(19) United States
(12) Patent Application Publication
(10) Pub. No.: US 2003/0120541 A1
(43) Pub. Date: Jun. 26, 2003

(54) Storage and delivery of electronic media content with advertising

(76) Inventors: Jonathan I. Siann, Rancho Santa Fe, CA (US); Anthony J. Wechselberger, Escondido, CA (US)

Correspondence Address: BROBECK, PHLEGER & HARRISON LLP, 12390 EL CAMINO REAL, SAN DIEGO, CA, 92130, US

(21) Appl. No.: 10/028,013

(22) Filed: Dec. 21, 2001

(51) Int. Cl. G06F 17/60

(52) U.S. Cl. 705/14; 725/32

(57) ABSTRACT

A method and device for electronically providing electronic media content and advertising content includes a media player and electronic media content from an electronic media content provider. The media player is electronically provided with the electronic media content via a first method of transmission. The media player is also electronically provided with advertising content, from an advertising content provider, via a second method of transmission. If necessary, the electronic media content is decrypted by the media player prior to the electronic media content being provided to the user. The media player electronically determines when advertising is to be played on the media player. Additionally, according to an embodiment, when the media player is disconnected from the first method of transmission, and the media player ceases to receive electronic media content via the first method of transmission, the media player is electronically provided with advertising content via the second method of transmission.

### RELATED APPLICATIONS

This application claims priority to U.S. Provisional Patent Application No. ______, filed Dec. 5, 2001, entitled “Pandrox Security Study,” which is incorporated herein by reference in its entirety.

### FIELD OF THE INVENTION

The invention relates generally to the storage and delivery of electronic media content and, more specifically, to a device, system and method for offering and distributing electronic media content with targeted, replenishable advertisements.

### BACKGROUND OF THE INVENTION

Current systems for the distribution of copyrighted audio media consist of retail sales, AM/FM radio, Internet based “radio” service, peer-to-peer music file sharing services, and pay/subscription based Internet websites. Similar systems exist for the distribution of copyrighted video media including rental and pay-per-view services. However, these methods are susceptible to abuses such as illegal copying and casual distribution. Such abuses result in significant loss of revenue to copyright holders that create and produce such media. Further, many of these current systems utilize high-bandwidth systems for the transmission of the media making portable transmission expensive to the provider or user. Thus, the current systems do not allow for the portable distribution of digital copyrighted media on demand at little or no cost to the user while at the same time providing compensation to copyright holders.

The retail sale of copyrighted media, through stores, the mail, rentals and on-line via the Internet, is problematic because the media can be illegally copied and distributed by a purchaser from a legitimate copy of the media. The copyright holder receives no compensation for the illegal copies.

Internet based “radio” services and AM/FM radio services, while providing some protection for copyright holders, do not allow the user to choose the content he or she is to listen to or view. These systems also cannot adapt to or integrate user preferences. In addition, AM/FM radio does not allow for highly targeted advertising based upon user preferences, interests or demographics. Internet based “radio” services require a full keyboard and display and a connection to the Internet, making transportation difficult. Furthermore, because of the random nature of advertisements that “pop-up” on the display with some Internet based “radio” services, Web page based advertisements are easy to ignore because they generally occupy only a small area of the display.

Peer-to-peer music file sharing services allow users to “pirate” copyrighted media, make illegal copies, and distribute electronic media content without compensating the copyright holder. Further, peer-to-peer music file sharing services also utilize high-bandwidth transmission methods, making transportation expensive for a user. However, peer-to-peer services demonstrate the demand among consumers for access to copyrighted media at little to no cost to the user.

Finally, pay/subscription services, while compensating the copyright holder, fail to meet the demand for access at little to no cost to the user. Moreover, in some systems, the media can be illegally copied and distributed by a purchaser. Further, these services again utilize high-bandwidth systems for the transmission of information making transportation expensive because of the high cost of high-bandwidth wireless transmissions.

Accordingly, there is a long felt need for the portable distribution of electronic media content that allows for equitable payment to the copyright holders of the media at little to no cost to the user. An additional advancement is needed which allows advertisers to monitor the user's interests and appropriately target advertising to users with particular preferences, interests or demographics.

### SUMMARY OF THE INVENTION

The present invention relates to the storage and delivery of electronic media content and advertising content by way of multiple methods of transmission to a media player. One embodiment of the present invention comprises a device, system and method for offering and distributing copyrighted media content with targeted, replenishable advertisements in a secure transmission environment by way of two methods of transmission wherein the copyright holder is compensated based upon advertising generated revenues. Additionally, according to an embodiment, advertisers can target advertising to particular users.

An embodiment of the present invention comprises a method of electronically providing electronic media content and advertising content, the method comprising the steps of: providing a media player; providing electronic media content; providing advertising content; electronically providing the media player with the electronic media content via a first method of transmission; electronically providing the media player with the advertising content via a second method of transmission; and wherein the media player provides the electronic media content to a user and further wherein the media player electronically controls when the advertising content is provided to the user.

An embodiment of the present invention comprises a media player that electronically provides electronic media content and advertising content comprising: an electronic media content storage device, wherein the electronic media content storage device receives and stores electronic media content; an electronic advertising content storage device, wherein the electronic advertising content storage device receives and stores advertising content; an output component that outputs the electronic media content and advertising content to a user, wherein the electronic media content that is encrypted is decrypted prior to being output; and an advertising control module, wherein the advertising control module electronically controls when advertising is provided to the user.

An embodiment of the present invention comprises computer executable process steps operative to control a computer, stored on a computer readable medium, comprising: a plurality of steps to receive data required for subsequent calculations; and a plurality of steps to automatically control when advertising content is provided to a user via a media player based on electronic media content that is provided by the media player to the user.

An embodiment of the present invention comprises a method for electronically providing electronic media content and advertising content, the method comprising: providing a media player; providing electronic media content, wherein the electronic media content is from an electronic media content provider; electronically providing the media player with the electronic media content via a first method of transmission; disconnecting the media player from the first method of transmission wherein the media player ceases to receive electronic media content via the first method of transmission; and after the step of disconnecting, electronically providing the media player with advertising content via a second method of transmission.

An embodiment of the present invention comprises a method for electronically providing electronic media content and advertising content, the method comprising: providing a media player; providing electronic media content; providing advertising content; providing access data regarding the electronic media content; electronically providing the media player with the electronic media content via a first method of transmission; decrypting the electronic media content; electronically providing the media player with the access data via a third method of transmission, wherein the media player provides the electronic media content to a user after the step of electronically providing the media player with the access data and after the step of decrypting; disconnecting the media player from the first method of transmission wherein the media player ceases to receive electronic media content via the first method of transmission; and after the step of disconnecting, electronically providing the media player with advertising content via a second method of transmission.

According to another embodiment of the present invention, the media player can be enabled in three forms with regard to the second method of transmission: (1) where the second method of transmission is physically similar to first method of transmission; (2) where the second method of transmission is physically different than the first method of transmission and the second method of transmission is a one-way link such that the media player can receive data but not transmit data; and (3) where the second method of transmission is physically different than the first method of transmission and the second method of transmission is a two-way link such that the media player can send and receive data.

A technical advantage of an embodiment of the present invention is that copyright holders are compensated for each delivery or use of their media. In one embodiment, copyright holders are compensated by advertisers whose advertisements are transmitted and replenished.

A further technical advantage of an embodiment of the present invention is that advertising content can be played along with electronic media content when the media player is disconnected from the first method of transmission.

A further technical advantage of an embodiment of the present invention is that the media player delivers electronic media content and advertising content while it is disconnected from the first method of transmission.

A further technical advantage of an embodiment of the present invention is that advertising content is replaced periodically with new advertisements keeping the advertising up-to-date while the media player is disconnected from the first method of transmission.

A further technical advantage of an embodiment of the present invention is that users are given the option to subscribe to a service or purchase the electronic media content and thereby receive the electronic media content without having to receive advertisements.

A further technical advantage of an embodiment of the present invention is that advertisers can track the number of media players receiving their advertising content, identification data regarding the users of such media players and how frequently the advertising content is being listened to or viewed.

A further technical advantage of an embodiment of the present invention is that the user can receive media content and advertisements while disconnected from means of external transmissions.

A further technical advantage of an embodiment of the present invention is that interactive advertisements are used. For example, through a user interface on the media player, the user can provide feedback on electronic media content or advertising content, which the advertising provider could then use to modify the advertising content that is provided to the user.

Other objects, features, and technical advantages of the present invention will become more apparent from a consideration of the detailed description herein and from the accompanying drawings.

### BRIEF DESCRIPTION OF THE DRAWINGS

Reference is now made to the following description and the accompanying drawings, in which:

FIG. 1A is a schematic system diagram illustrating an embodiment of the present invention;

FIG. 1B is a schematic system diagram illustrating an embodiment of the present invention that includes access data;

FIG. 2 is a schematic system diagram illustrating another embodiment of the present invention;

FIG. 3 is a schematic system diagram illustrating another embodiment of the present invention;

FIG. 4 is a schematic system diagram illustrating a media player according to an embodiment of the present invention;

FIG. 5 is a flow chart illustrating an embodiment of the present invention; and

FIG. 6 is a flow chart illustrating another embodiment of the present invention showing how the media player determines whether advertising content is to be played.

### DETAILED DESCRIPTION OF AN ILLUSTRATIVE EMBODIMENT

The following detailed description refers to the accompanying drawings. Other embodiments are possible and modifications may be made to the embodiments without departing from the spirit and scope of the invention. Therefore, the following detailed description is not meant to limit the invention. Rather the scope of the invention is defined by the appended claims.

For convenience in the ensuing description, the following explanations of terms are adopted. However, these explanations are intended to be exemplary only. They are not intended to limit the terms as they are described or referred to throughout the specification. Rather these explanations are meant to include any additional aspects and/or examples of the terms as described and claimed herein.

“Electronic media content” includes audio and/or visual data, textual data and/or graphical data. In one embodiment, the electronic media content is copyrighted electronic media content, such as an audio artistic work or a video artistic work.

“Advertising content” refers to a notice or message, such as an announcement in the print, broadcast, or electronic media, designed to attract public attention or patronage. It includes the activity of attracting public attention to a product, service or business, as by paid announcements in the print, broadcast, or electronic media. It includes audio and/or visual advertisements.

“Media player” refers to a portable device that plays electronic audio and/or video content and can electronically receive a transmission for electronic media content and advertising content.

A “memory storage device” is a device that interacts directly with the media player and provides data to the media player, including without limitation, a CD-ROM, a DVD, a floppy diskette, other diskettes, a hard drive, RAM memory, ROM memory, flash memory, or any other machine-readable storage medium.

“Access data” refers to data, for example decryption keys, that is used to ensure that a media player can decode secured electronic media content. Access data can be in the form of decryption keys, authorization codes, or the like.

“Access rules” refers to criteria that is used by the media player to determine if the media player should be disabled from playing electronic media content.

“First method of transmission” refers to the method in which electronic media content is transmitted to the media player. It includes, without limitation, interactive, high bandwidth transmissions, connections to the Internet, wireless LAN (“Local Area Network”) connections, wireless Internet connections via 2.5G or 3G cellular networks, standard dial-up-modem connections (such as V32.bis, VLAN (“Virtual Local Area Network”), cable modem, DSL (“Digital Subscriber Line”) other Internet connections, and the like), or other such systems that allow access to the Internet. Alternatively, the first method of transmission may be any method of transmission that may be used as the second or third method of transmission, may be the second or third method of transmission or may be a side channel of the second or third method of transmission. According to another embodiment, advertising content, access data is also transmitted via the first method of transmission.

“Second method of transmission” refers to the method in which advertising content is transmitted to the media player. It includes, without limitation, any wireless infrastructure including, but not limited to, ATSC (“Advanced Television Systems Committee”), any one-way or two-way wireless service, one-way or two-way paging, 3G (“Third Generation”) cellular networks, SMS (“Short Messaging System”) on GSM (“Global System for Mobile Communications”) networks, CDPD (“Cellular Digital Packet Data”), 2.5G cellular networks running GPRS (“General Packet Radio Service”)/EDGE (“Enhanced Data rates for Global Evolution”), one-way or two-way data transmission infrastructures including cellular phone systems or VHF/UHF terrestrial systems or any other such known service. Alternatively, the second method of transmission may be any method of transmission that may be used as the first or third method of transmission, may be the first or third method of transmission or may be a side channel of the first or third method of transmission. According to one embodiment the second method of transmission is a one-way transmission and according to another embodiment, the second method of transmission is a two-way transmission. According to another embodiment, when the second method of transmission is a two-way transmission, user data can be transmitted to a coordination system via the second method of transmission.

“Third method of transmission” refers to the method by which access data and/or access rules are transmitted to the media player. This method of transmission includes any wireless infrastructure include, without limitation, ATSC, any one or two-way wireless service, one or two-way paging, 3G cellular networks, SMS on GSM networks, CDPD, 2.5G cellular networks running GPRS/EDGE, one or two-way data transmission infrastructures including cellular phone systems or VHF/UHF terrestrial systems or any other such known service. Alternatively, the third method of transmission may be any method of transmission that may be used as the first or second method of transmission, may be a side channel of the first or second method of transmission or may be the first or second method of transmission.

A “User” is any individual or entity who uses a media player for the delivery of electronic media content. Generally, the user will be at least one individual but the user may be multiple individuals or a computer. With regard to the present invention the number of users is not considered a limiting aspect. In particular, there can be as many users as are capable of accessing the electronic media content.

“Advertising criteria” refers to the criteria that is selected by the advertising provider for determining what advertising content to provide to a particular user or a group of particular users. By way of example, the advertising provider may select advertisement “A” for users of a particular age group, advertisement “B” for users of a particular geographic location, and so on. In one embodiment, the advertising provider selects the particular advertising content to be provided before the advertising content is transmitted to the media player. In one embodiment, the advertising criteria is based upon user data. In another embodiment, the advertising content is randomly selected.

“User interface” refers to a display and/or controls on the media player including, but not limited to, controls such as play, pause, stop, mute, yes, no, volume level and the like.

“Automatic,” “automatically,” “automated,” or the like, as used herein, means to occur without human interaction. For example, this may mean that the event has occurred using a computer that is programmed to perform the event using information that the computer has received, obtained and/or gathered. Operation of some embodiments of the present invention allow for the elimination of substantial human effort at various phases, such phases are described herein as being “automatic,” “automated,” occurring “automatically,” or the like. However, human intervention may occur such that that such phases may be completed manually.

“User data” refers to information that is provided by the user including, but not limited to, the user's preferences, interests, demographics (such as age, sex, marital status, profession, geographic location, and the like) desired electronic media, billing data, and the like. In one embodiment, the user data is gathered and stored by the media player by way of the user interface on the media player. In one embodiment, the user data is transmitted via the second method of transmission to the advertising content provider or the electronic media content provider. In another embodiment, the user data is provided by the user when he or she registers his or her media play. Such registration can occur over the Internet, over the telephone, via the mail, in person, via a handwritten registration card, or the like. Additionally, the user data may be periodically updated by the user or automatically by the media player.

“Advertising control module” refers to software and/or hardware that controls when advertising content is to be played by the media player.

A “computer,” as used herein, includes any general-purpose machine that processes data according to a set of instructions that is stored internally either temporarily or permanently, including, but not limited to, a general purpose computer, workstation, laptop computer, personal computer, set top box, web access device (such as WEB TV™ (Microsoft Corporation)), television interfaces, kiosks, cable television, satellite television, broadband network, an electronic viewing or listening device, wireless devices, such as a personal digital assistant (“PDA”), cellular or mobile telephones, an electronic handheld unit for the wireless receipt and/or transmission of data, such as a BLACKBERRY™ (Research In Motion Limited Corporation), or the like.

“Secure manner” or “secured” refers to providing electronic media content in an exclusive, private manner. Such access can be granted to a user by access data. Encryption methods can also be used to provide access to the electronic media content on an exclusive basis. Encryption methods involve transmitting media from the electronic media content provider in a manner which must be translated by an encryption system that is running on both the electronic media content provider and the media player. Electronic information may also be kept on the media player storage device in a secure manner allowing access to users that have the proper access data.

“Electronic connection,” as used herein, is any electronic connection, including connections via hardwire, Ethernet, token ring, modem, digital subscriber line, cable modem, wireless, radio, satellite, and combinations thereof Such connections may be implemented using copper wire, fiber optics, radio waves, coherent light, or other media.

It will be apparent to one of ordinary skill in the art that an embodiment of the present invention, as described below, may be realized in a variety of implementations, including the software, firmware, and hardware of the entities illustrated in the figures. The actual software code or control hardware used to implement the present invention is not limiting of the present invention. Thus, the operation and behavior of the present invention will be described without specific reference to the actual software code or hardware components. Such non-specific references are acceptable because it is understood that a person of ordinary skill in the art would be able to design software and control hardware to implement the present invention based on the description herein.

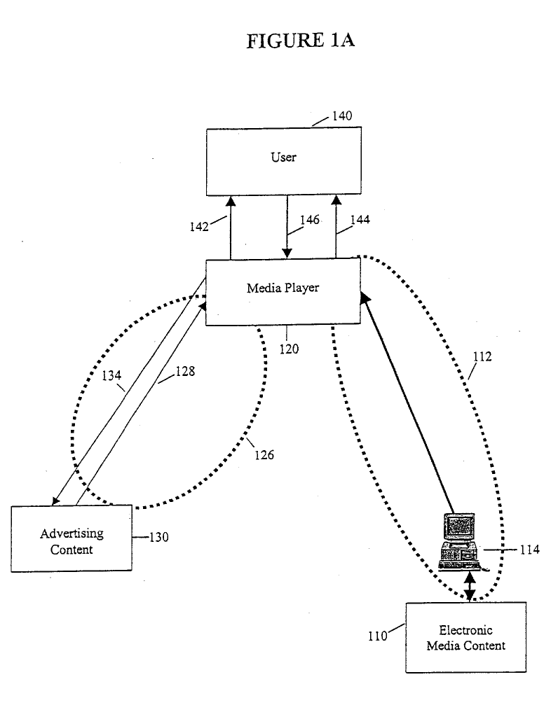

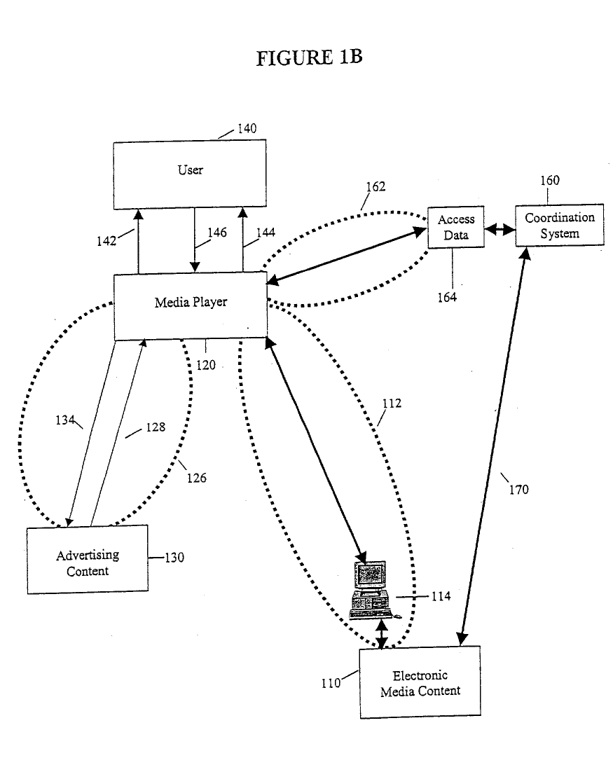

FIG. 1A is a schematic system diagram illustrating an embodiment of the present invention. A media player 120 receives electronic media content 110 and advertising content 130. Additionally, the media player 120 can receive other content, such as access data. A user selects the desired electronic media content 110. Electronic media content 110 is provided via a first method of transmission 112. Advertising content 130 is provided to media player 120 via a second method of transmission 126. Media player 120 provides electronic media content 144 to user 140. Media player 120 controls when, what and/or how much 140 advertising content 130 is played on media player 120.

Media player 120 is used for storing and delivering electronic media content 110, and providing electronic media content 110 and advertising content 130 to the user. Alternatively, multiple media players may be used. Additionally, the media player 120 collects, receives and stores user data 146 and provides user data to advertising content provider 134 via the second method of transmission 126.

The user does not have to pay for use of the electronic media content 110, or alternatively pays a reduced fee for use of the electronic media content 110, because of the advertising content 130. Advertisers pay to have their products or services promoted in the advertising content 130. At least a portion of these payments are used to compensate the owners of the electronic media content 110. Therefore, by having the advertising content 110 played along with the electronic media content, users pay a reduced fee or pay no fee to play the electronic media content 110.

In one example, the second method of transmission 126 is a wireless infrastructure with wide geographical coverage. The second method of transmission 126 broadcasts the advertising content 130 to the media player by utilizing a fixed set of advertising channels with pre-created slots for each advertising spot. Thus, depending on the second method of transmission 126, the advertising content 130 may be transmitted via a low cost wireless infrastructure. By way of example, the second method of transmission 126 may be any broadcast method, such as a multicast, ATSC or a wireless digital system implement available on many North American terrestrial television transmitters or stations. By way of another example, the second method of transmission 126 may be any two-way wireless service which operates in a broadcast manner, such as two-way paging, 3G cellular networks, SMS on GSM networks, CDPD, 2.5G cellular networks running GPRS/EDGE, or any other such service known in the art. By further way of example, the second method of transmission may be a paging network that costs $0.05 per kilobyte of information to send in a local area. Thus, to send 1 megabyte of data in this local area costs $50.00. However, this data may be received and used by a large number of users. If 100,000 subscribers were in this area, to send such a broadcast would only cost $0.0005 per user.

In another embodiment of the invention, the second method of transmission 126 is a two-way data transmission infrastructure. The second method of transmission 126 transmits low bandwidth advertising content 130, the user data 134 and other data (such as current status of playback, identification data, access data, and the like), to and from the media player 120. By way of example, the second method of transmission 126 may be any two-way data transmission infrastructure, such as cellular phone system, SMS on GSM networks, CDPD, 2.5G cellular networks running GPRS/EDGE, two-way paging infrastructures or VHF/UHF terrestrial systems.

Additionally, the second method of transmission 126 may continuously loop various different advertising content 130. This loop is shown as a dashed loop in FIG. 1A. When media player 120 is required to play at least one advertisement, the media player 120 plays the start of the next advertisement being transmitted via the second method of transmission 126.

According to an embodiment of the invention, the first method of transmission 112 is an interactive, high bandwidth transmission. The interactive nature of the first method of transmission 112 allows for the user to select specific media to be transmitted to the media player 120. By way of example, the first method of transmission 112 may be a wireless LAN, wireless Internet connections via 2.5G or 3G cellular networks, standard dial-up-modem connections (such as V32.bis, VLAN connections to the Internet, cable modem, DSL Internet connections, or the like), or other systems allowing such access to the Internet. Alternatively, the first method of transmission 112 may be substituted for the second method of transmission 126 when the second method of transmission 126 is unavailable 126 or vice versa.

According to another embodiment of the invention, the first method of transmission 112 is a direct electronic connection (such as a FireWire connection, USB, serial connection, parallel connection, and the like) and the second method of transmission 126 is a wireless method of transmission.

According to another embodiment, the first method of transmission 112 and the second method of transmission 126 may use different antennas or use the same antenna on the media player. Alternatively, the first method of transmission 112 and the second method of transmission 126 can use the same antenna on the media player, using different power settings for the first and second methods of transmission.

Additionally, a transceiver on the media player can run in different power and/or bandwidth settings, such that the first method of transmission 112 is the transceiver running in high power and/or bandwidth mode and the second method of transmission 126 is the same (or a different) transceiver running in low power and/or bandwidth mode. An example of this may be next generation local area network (“LAN”) standards, such as versions of Bluetooth, IEEE 802.11a and IEEE 802.11b.

In another embodiment of the invention, the first method of transmission 112 is through an Internet Web server 114. The electronic media content 110 is loaded onto the Web server 114, making the electronic media content 110 accessible to Internet users. These users can then access the Web server 114, survey the available electronic media content 116 stored on the Web server 114, and then transmit the selected electronic media content 116 onto the media player 120 via the first method of transmission 112. The user can periodically update, change, or remove electronic media content on the media player 120, such as by accessing the first method of transmission 112. Alternatively, the user of the media player 120 can update the electronic media content 110 stored on his or her media player 120 by purchasing a memory storage device that can be inserted into the media player (or some other attached device, such as a memory storage device reader), such that the electronic media content 110 is loaded onto the media player 120.

Additionally, the user can backup the electronic media content 110 stored in his or her media player 120, such as on a computer data file, over the Internet, or the like. Therefore, if the user desire to use a different media player (such as an updated version or the media player of a friend), his or her media player 120 is lost or damaged or the electronic media content becomes corrupted, the user can download the backed up electronic media content to the desired media player.

Additionally, according to an embodiment, the user can store various electronic media content on a computer or over the Internet and download the electronic media content desired to a media player. The user can perform such downloads when desired, and thus need not store all of the electronic media content on the media player.

In another embodiment, the first method of transmission 112 continuously loops various different electronic media content 110. This loop is shown as a dashed loop in FIG. 1A. When a media player 120 is instructed to play some electronic media content 110, such as an audio artistic work, the media player 120 plays the start of the next audio artistic work being transmitted via the first method of transmission 112.

In another embodiment of the invention, the electronic media content 110 and/or advertising content 130 are pre-loaded onto the media player 120 before the user purchases the media player 120. The media player 120 can determine if the electronic media content was purchased (such as via a header of the electronic media content) so that advertising content is not played while the user is using this electronic media content. However, the pre-loaded electronic media content may be changed or added to via the first method of transmission, such that when this changed/added electronic media content is played, the media player 120 determines whether use of this changed/added electronic media content 110 requires the playing of advertising content 140, if necessary.

In another embodiment of the invention, the electronic media content 110, that has been purchased or is otherwise owned by the user, is downloaded to the media player. This electronic media content contains a header that notes whether the electronic media content 110 requires use of advertising content or not. Also the identity of the electronic media content can be established by the media player (if not previously part of the header) and this information can be assembled and/or inserted into the header. This identity can be established for example using software containing a database of known electronic media content, such as GRACENOTE™ (CDDB, Inc.). Knowing the identify of the electronic media content allows this content to be subject to similar access/benefits of the system as stated herein.

If the electronic media content 110 was purchased or is otherwise owned by the user, advertising content is not played while the user is using this electronic media content 110. However, the purchased electronic media content 110 may be changed or added to via the first method of transmission, such that when this changed/added electronic media content is played, the media player 120 determines whether use of the changed/added electronic media content 110 requires the playing of advertising content 140.

In one embodiment, for electronic media content 110 of another that has not been purchased by the user (e.g, pre-purchased, purchased when the content was downloaded, owned by the user, or the like), the media player 120 monitors the number of times such electronic media content 110 has been played without advertising content 130 having been played and/or demographics to determine when to play advertising content 130. The advertising control module makes this determination of when to play advertising content 130. The advertising control module uses a formula to make such a determination. This formula considers demographics of the electronic media content being played (e.g., jazz, classical, rock & roll, and the like), demographics of the user (if known), time since that last advertisement content 130 was played, the number of times electronic media content 110 has been played without advertising content 130, and/or other similar criteria. For example, a user between the ages of 18-24, listing to jazz music that was not purchased (e.g. the user is to listen to advertising content), where the user has listened to five audio artistic works without hearing an advertisement and has not listened to an advertisement in over one hour, the user would have to hear an advertisement before hearing another audio artistic work. The advertisement could be tailored to the user based on the above information, for example an advertisement for a jazz concert.

Additionally, the advertising control module can utilize “smart mixing,” such that the advertising content is played prior to the end of the electronic media content, to match the electronic media content, or overlaid with the electronic media content. Such smart mixing provides the user with a seamless transition from electronic media content to advertising content. Further, by providing this smart mixing (in a non-predictable fashion), individuals would be discouraged from copying the electronic media content via analog means because a “clean/complete” copy of the electronic media content would be more difficult to obtain.

The media player 120 may also monitor the period of time between advertising content updates 128. If a pre-programmed length of time passes without advertising content updates 128, then the media player is disabled from playing electronic media content 112 or the user listens to the already stored advertising content 130 until the advertising content is replenished and/or updated. If the media player 120 is not cable of currently receiving updated advertising content 128 via the second method of transmission 126, the media player can play advertising content 130 stored in the media player 120. This advertising content 130 can be pre-loaded onto the media player prior to being purchased or alternatively is the last few advertisements played on the media player 120. Alternatively, if the media player does not receive the transmitted advertising content, the media player can be equipped to receive such transmissions via an alternative method of transmission, such as via UHF, VHF, FM or AM transmission or the like.

In another embodiment, the media player prevents users 140 from blocking or tampering with the playback of the advertising content 130. The media player 120 can monitor the volume and on/off switch, to ensure the advertising content 130 is being played. If the volume is turned too low or muted or the media player 120 is turned off during the playback of advertising content, the media player 120 may be disabled from playing electronic media content 110 until the user turns the volume up or turns the media player 120 on to play the advertising content 130.

In another embodiment, the media player 120 contains the capability to disable the media player from playing media content, if the access rules are not met. The access rules include, but are not limited to, the length of time between playing of advertising content, the age of the advertising content, the volume level during advertising, whether the media player is in a standby mode, whether the media player is turned off during playback of advertising content, whether a subscription or usage payment has been made, whether a user's account is in good standing, if the media player has been reported stolen, and/or the like.

Additionally, in one embodiment, the user 140 subscribes to the electronic media content provider to obtain access to the electronic media content 110 on a pay-per delivery or use basis. In this embodiment, the electronic media content 110 is transmitted via the first method of transmission 112 and the billing information is transmitted via the first method of transmission or the second method of transmission to the electronic media content provider. When the user subscribes with the electronic media content provider, the media player need not play advertising content when the electronic media content from this electronic media content provider is player.

In another embodiment of the invention, the media player 110 includes a user interface allowing the user 140 to provide feedback on any electronic media content 110 or advertising content 130. This feedback, or user data 134, is transmitted to the advertising content provider via the second method of transmission 126. Alternatively, the user data 134 could be transmitted via the first method of transmission 112, such as via an Internet connection. This user data 134 could be used to modify the advertising content 130 transmitted to the media player 120 based upon advertising criteria that is pre-selected by the advertising provider. By way of example, the advertising criteria includes, but is not limited to, media content selections, the demographics of the user, the user's advertising preferences, and the like.

Alternatively, according to an embodiment, a large portion of the electronic media content (such as 90% or more, 95% or more, or 99% or more of the electronic media content) is transmitted via the first method of transmission, such that the electronic media content could not be adequately played. The remaining electronic media content is transmitted via the second method of transmission. By breaking the transmission of the electronic media content into two transmissions, a user would have to receive both transmissions to adequately play the electronic media content.

According to an embodiment, the electronic media content comprises a header. This header includes information regarding the electronic media content (such as the genre of the electronic media content), access data, access rules, user data, auxiliary data (such as where the electronic media content was purchased/received) and/or the like. For example, the header includes information on whether this electronic media content requires the playing of advertising content. Alternatively, if the electronic media content requires advertising content to be played, the header of the electronic media content indicates that advertisements are to be played periodically with this electronic media content. Electronic media content that does not require the playing of advertising content is deemed premium content while electronic media content that does require the playing of advertising content is deemed standard content. The header can utilize one bit (or one byte or the like) to indicate standard or premium content. Additionally, the header can include demographics on the user or the electronic media content.

FIG. 1B illustrates another embodiment of the present invention that includes access data. FIG. 1B is similar to FIG. 1A with the addition of a coordination system 160 that provides access data 164. Access data 164 is provided to the media player 120 from a coordination system 160. The coordination system 160 is the system that oversees the providing of electronic media content and advertising content to the media players and in one embodiment oversees the payment of revenue from advertising content providers to electronic media content providers. Access data 164 allows the electronic media content 110 to be secure, such that the electronic media content 110 is useable only if the proper access data has been provided to the media player 120. By using access data, secure electronic media content is decrypted.

In one embodiment, the media player 120 requests the access data 164 from the coordination system 160, such as when a user desires to play the electronic media content 110 or the coordination system 160 can send the media player 120 the access data 164 periodically. In one embodiment, the access data 164 is transmitted via a third method of transmission 162. Alternatively, access data 164 is transmitted via the first method of transmission 112 or the second method of transmission 126. The third method of transmission 162 can continuously loop the access data 164, such that media player 120 can receive the transmission when it is capable. This loop is shown as a dashed loop in FIG. 1B.

The access data is associated with electronic media content via 170. For example, once electronic media content is downloaded or purchased by a user, an indication is sent to coordination system 160 and access data is generated. The access data is then provided to the media player via the third method of transmission 162. Alternatively, the access data is provided to the media player along with the electronic media content.

In another embodiment of the invention, the media player can arrange for the advertising content and/or user data to be transmitted/received in a secure fashion. For example, such secure fashion can be similar to that as described herein for electronic media content.

According to an embodiment, the first method of transmission 112 (for electronic media content), the second method of transmission 126 (for advertising content) and the third method of transmission 162 (for access data) are three different methods of transmission used, such that at least a portion of the advertising content 130, at least a portion of the electronic media content 110 and at least a portion of the access data 164 is transmitted via different methods. These transmission methods may use the same physical transmission mediums, provided however, that the system's security model is not compromised.

According to another embodiment of the present invention, the media player can be enabled in three forms with regard to the second method of transmission: (1) where the second method of transmission is physically similar to first method of transmission; (2) where the second method of transmission is physically different than the first method of transmission and the second method of transmission is a one-way link such that the media player can receive data but not transmit data; and (3) where the second method of transmission is physically different than the first method of transmission and the second method of transmission is a two-way link such that the media player can send and receive data.

An example of where the second method of transmission is physically similar to first method of transmission is when the first and second method of transmission is the Internet. The media player receives electronic media content and advertising content via the Internet and is able to play the electronic media content and advertising content when disconnected from the Internet. However, the media player could not receive updates of the advertising content or any additional electronic media content when disconnected from the Internet. Additionally, access data can also be provided via the Internet, such that the access data instructs the media player that the electronic media content can be used. The access data can be provided to the media player upon registration by the user, payment of a fee, or the like. For example, the access data could instruct the media player that the electronic media content can be played a certain number of times, a certain number of days, a certain length of time, or the like, prior to expiring. After expiration, the electronic media content could not be played by the media player, unless the media player received new and/or updated access data (for example, by connecting the media player to the Internet and paying a fee).

An example of where the second method of transmission is physically different than the first method of transmission and the second method of transmission is a one-way link such that the media player can receive data but not transmit data is where the second method of transmission is a one-way wireless transmission and the first method of transmission is the Internet. Electronic media content is downloaded to a media player via the Internet. The media player receives wireless transmissions of advertising content, while connected or disconnected from the Internet. However, the media player cannot upload information via the second method of transmission, the media player just receives information via the second method of transmission.

An example of where the second method of transmission is physically different than the first method of transmission and the second method of transmission is a two-way link such that the media player can send and receive data, is where the second method of transmission is a two-way wireless transmission and the first method of transmission is the Internet. Such an example could be similar to the above example regarding a one-way link except that the media player is capable of sending and receiving data. Such information can include user data or any other data desirable to be collected. The information could be transmitted to the coordination system for collection and processing.

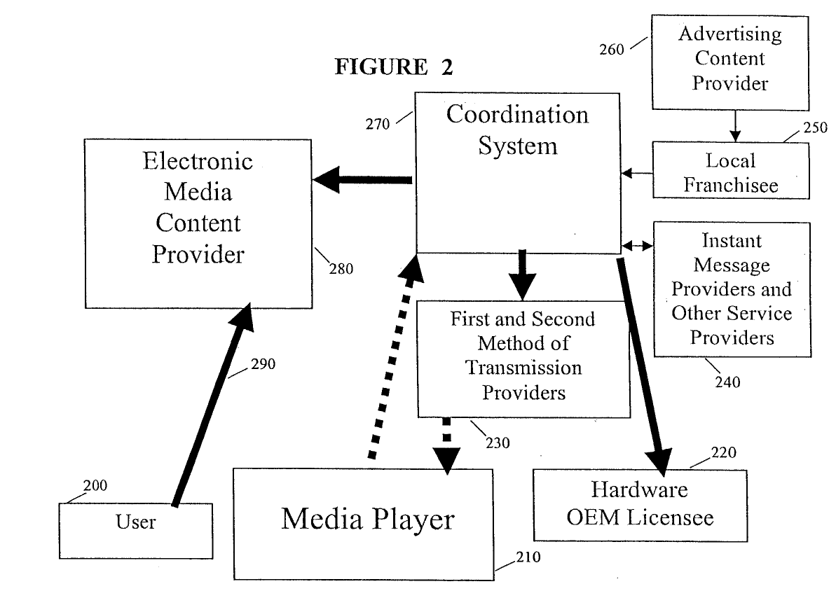

FIG. 2 illustrates another embodiment of the present invention wherein the advertising content providers 260 pay the local franchisee 250 who pays a coordination system 270 for providing the advertising content to users.

The electronic media content providers are paid with at least a portion of the money advertising content providers pay the coordination system for airing their advertising content. The electronic media content providers could be paid each time their content is played by a user, each time their content is downloaded by a user onto the media player, a flat rate each month or day, or the like.

Alternatively, instant message providers 240 and other service providers, pay the coordination system 270 for providing its services to the users or vice versa. These other service provides could be a provider that desires to have information instantly sent to a number of media players, such as providers of a product list, real estate listing or other such information. The coordination system 270 pays the wireless infrastructure service provider 230 who provides the advertising content or the services via the second method of transmission. The coordination system 270 pays the content providers 280 for use of the electronic media content. Further, the user can purchase a memory storage device that can be inserted into the media player to provide electronic media content, in which case when purchasing such a memory device, the user 200 pays the content provider 280 on a per use or per copy basis 290 for use of the electronic media content.

According to another embodiment, the media player can identify the OEM (“Original Equipment Manufacturer”) of the media player, using a code that is imbedded in a chip on the media player. In this embodiment, when advertising content is played on a particular OEM's media player, the coordination system 270 pays the OEM 220 a revenue stream.

Further, according to another embodiment, the media player includes a unique identifier that is imbedded in a chip on the media player. This unique identifier provides information on the particular media player that is being used and/or on the user of the media player. Additionally, the unique identifier allows the media player to be tracked and/or located, using GPS (“Global Positioning System”), a triangulation of signals, or other methods of tracking the location of an object. Further, according to an embodiment, using the unique identifier, advertising content providers can be provided with data regarding the number of media players receiving their advertising content, identification data regarding the users of such media players and how frequently the advertising content is being listened to or viewed. This data is stored by the media player and transmitted using the second method of transmission.

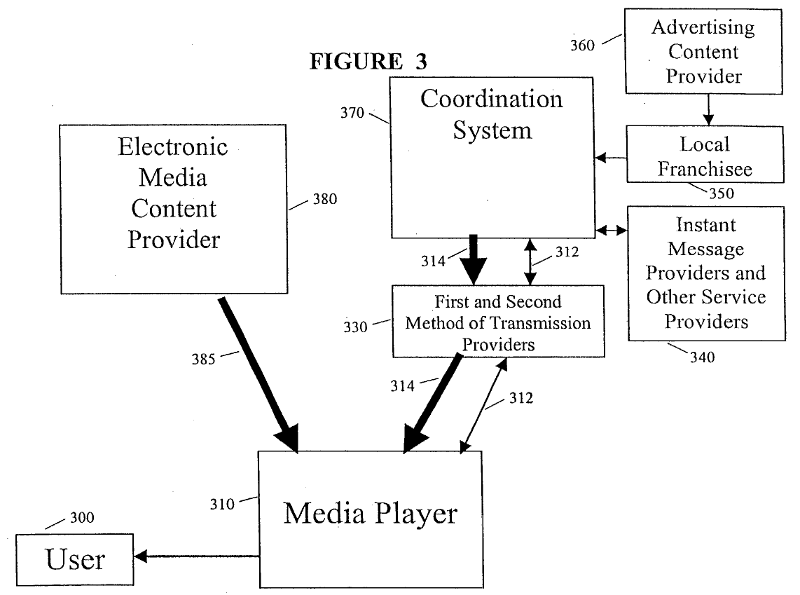

FIG. 3 illustrates an alternative embodiment of the present invention wherein advertising content providers 360 provide the advertising content to a local franchisee 350. The local franchisee 350 provides the advertising media content to the coordination system 370.

According to an embodiment, instant message providers 340 and other service providers provide services to the coordination system 270 or vice versa. The coordination system 370 provides the advertising content or the services to the wireless infrastructure service provider 330 via the first method of transmission or via the second method of transmission. The second method of transmission includes, but is not limited to, any low bandwidth mobile wireless two way communication system in the art. The first method of transmission includes but is not limited to any high bandwidth mobile wireless broadcast communication system in the art. The wireless infrastructure service provider 330 delivers the advertising content or services to the media player 310 via the first method of transmission or via the second method of transmission. The content provider 380 provides the electronic media content to the media player 310 via the first method of transmission. The electronic media content is transmitted in a secure manner to the media player 310. The media player 310 provides the electronic media content and the advertising content to the user 300.

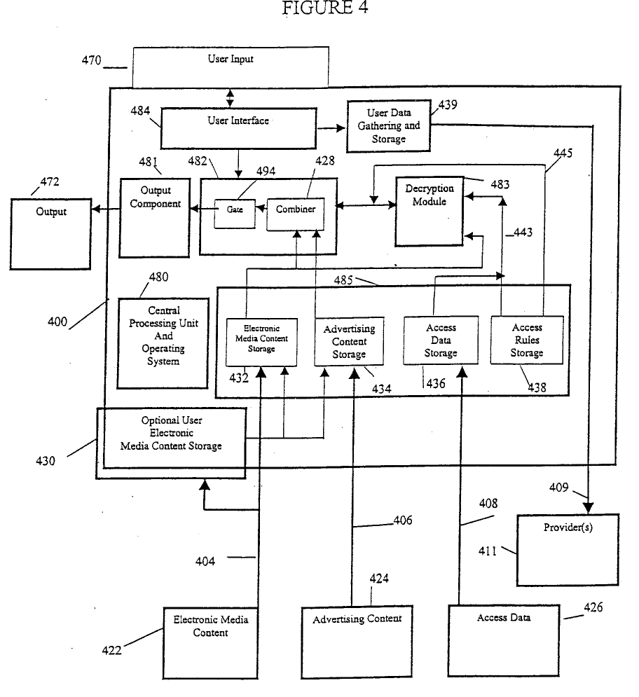

FIG. 4 illustrates a media player 400 according to an embodiment of the present invention. A CPU and operating system 480 act as the central hardware and software of the media player 400. In this figure, the first method of transmission 404, second method of transmission 406, third method of transmission 408, and method of transmission 409 are shown with a darker arrow than the other arrows shown in FIG. 4.

As stated herein, electronic media content 422 may be secured for delivery or storage in many of the embodiments described herein. A preferred method of securing and storing electronic media content 422 is through the use of digital encryption technology to secure content for distribution, and employing associated cryptographic “keys” as part of the aforementioned access data used for decrypting content in the media player 400, if the access rules are satisfied.

In one embodiment, secure storage device 485 comprises an electronic media content storage device 432, an advertising content storage device 434, an access data storage device 436 and an access rules storage device 438. Access rules provide information for the CPU and the operating system 480, which is used by the advertising control module 482 to determine whether or not to allow electronic media content 422 to be used by the user. The access data 426 provides a hard security “overlay” or protection means for the system to be able to insure that the electronic media content, advertising content, access rules and/or the messaging associated therewith is confidential, trustworthy and secure against tampering or other forms of attacks.

In one embodiment, a fourth method of transmission is used to deliver access data associated with a certain electronic media content from the provider of electronic media content to a coordination system. For example, the fourth method of transmission is shown as 170 on FIG. 1B. The access data can then be delivered to the media player, such as via the third method of transmission 408. For example, when a user downloads electronic media content, like an audio artistic work, the provider of the audio artistic work can secure the audio artistic work thereby creating access data for this audio artistic work and sends this access data to a coordination system. The coordination system then sends the access data via the third method of transmission 408 to the media player 400. The fourth method of transmission can be any method of transmission used for the first, second or third method of transmission. In one embodiment, media player 400 is not aware of data being transmitted via the fourth method of transmission. Further, information transmitted via the fourth method of transmission (or any of the methods to transmission) may be stored (up to an indefinite amount of time) waiting for an appropriate connection to deliver this data.

According to an embodiment, to provide flexibility in the use of cryptographic mechanisms for such security, access data storage device 436 contains tables of parameters which include an identification part and a cryptographic key part, such that both are used to deliver access data and access rules, and other information to the media player in a cryptographically secure manner. A further embodiment allows access rules, access data and other generalized messages to be delivered to the media player uniquely, by groups, or globally, according to how the identification parameters are defined, and how their associated key variable parts are employed. Some or all of such parameters are specific and/or confidential to a certain media player, groups of players, or other such combinations. The system is not limited to a particular cryptographic security solution, but instead, the use of media player identifications can be based upon “groupings,” multi-variable key sets that can be used with such grouping identifications, and the basis for system security and trust requirements for communications over the first, second and third methods of transmission can be supported by parametric data stored in the media player to effect cryptographic levels of security.

Referring again to FIG. 4, electronic media content 422 is provided by either an optional user electronic media content storage 430 (if the electronic media content has already been stored by the media player) or via the first method of transmission 404 to the electronic media content storage 432. In one embodiment, the user electronic media content storage 430 is removable, such as a removable memory storage device. Alternatively, the electronic media content 422 may be transmitted to the user electronic media storage 430 via the first method of transmission 404. If the methods of transmission involve wireless transmission, a transceiver is used in the media player to receive such transmission.

Advertising content 424 is provided via the second method of transmission 406 to the media player 400 and is received and stored in advertising content storage device 434. The access data 426 is transmitted via the third method of transmission 408 and stored in the access data storage device 436, in the secure storage device 485 of the media player 400. Alternatively, the access data 426 can be transmitted via the first method of transmission 404 or the second method of transmission 406.

According to another embodiment, access rules are transmitted via the third method of transmission 408. The access rules are then stored in the access rules storage device 438, in the secure storage device 485 of the media player 400. Alternatively, access rules may be pre programmed in the media player 400 and stored in access rules storage device 438. Alternatively still, the access rules are transmitted via the first method of transmission 404 or the second method of transmission 406.

The access rules 436 are communicated to the advertising control module 482 by data path 445. Alternatively, the access rules 436 are communicated to decryption module 483 via path 443.

The access data storage device 436 holds the access data, such as decryption keys. The access data storage 436 provides the access data to the decryption module 483, which decrypts any secure content. The advertising control module 482 determines if electronic media content 422 should be decrypted and, if so, directs the decryption module 483 to decrypt the electronic media content using the appropriate access data provided by access data storage device 436. If the proper access rules and access data keys are not available, the encrypted electronic media content is not played. If the electronic media content does not need to be decrypted, the electronic media content passes through to the advertising control module 482.

The advertising control module 482 contains at least a gate 494 and a combiner 428. Gate 494 prevents the playback of electronic media content if the access rules are not satisfied, for example that advertising content has not been played a sufficient amount. For example, the access rules can be checked prior to allowing content decryption and combining. Therefore, the electronic media content 422 is not played unless the user is licensed, e.g., the access data and access rules are satisfied.

Combiner 428 controls when advertising content is to be played. Additionally, the combiner 428 can provide smart mixing, as described herein. Gate 494 provides the electronic media content 422 to the output component 481. The output component 481 includes, but is not limited to, a supply analog output, a modulated output which can select the frequency of the transmission channel for user convenience and the like. The output component 481 provides the electronic media content 422 and the advertising content 424 to the output 472, such that the user can use the electronic media content. The output 472 can be audio, video, textual or the like.

In conjunction with the multiple identification and key variables that may be used as access data, access rules storage device 438 may include storage of multiple types or definitions of access rules that may be associated with the groupings stored in 436. A further embodiment may provide that electronic media content may be associated with any desired combination of access rules, providing enhanced flexibility over user and content access control and the user's relationship with the coordination system.

The user interface 484 in the media player 400 collects user data including, but not limited to, user electronic media content preferences, demographics, advertising content interests, billing data or the like. The user input device(s) 470 include(s), but are not limited to, user controls such as play, pause, stop, mute, yes, no and the like. The user data is collected and stored in the user data gathering and storage module 439. The user data gathering and storage module 439 transmits the user data to an appropriate provider (whom would be interested in receiving this user data, such as provider(s) 411 of the advertising content and/or the provider of the electronic media content) via method of transmission 409, which can be either the first, second or third method of transmission.

In another embodiment of the invention, the media player allows the user to receive additional product information regarding the advertised product or purchase the advertised product. The user may indicate such a desire using any valid user input device(s) 470 (such as buttons, touch screen, keys, switches, and the like) on the media player. For example, one selection on the user input device(s) 470 can be used to make an instant purchase of an advertised product and a second selection on the user input device(s) 470 can be used to indicate a desire to have more information sent to the user regarding an advertised product. When a user selects one selection on the user input device(s) 470, an instant purchase may be made, or the user may select to have a password be required to enable the purchase. When the user selects another selection on the user input device(s) 470, depending on a pre-selection made by the user (such as when registering the media player, over the Internet or a selection made on the media player), information regarding the advertised product is sent via the second method of transmission, first method of transmission or third method of transmission, e-mail, the mail or any other such method of receiving information regarding a product that the user has selected.

In one embodiment, storage devices 432, 434, 436, 438 and 439, or any combination thereof, can be embodied in one device, such as a memory chip. According to another embodiment, the media player could be embodied in a SIM (“Subscriber Identity Module”) card, or other such card, such that the SIM is placed in an audio or video device and the audio or video device would then utilize the services of the media player. To embody the media player in a SIM, devices 482, 483 and/or 485 are electronically created in a SIM. Additionally, the media player can be inserted into, used in conjunction with, or built into (for example, using the core elements of the media player on a chip) an automobile audio or video device, an airplane audio or video devices, a cellular phone, or the like. Additionally, some or all the elements shown in FIG. 4 can be modular, such that parts of a media player can be inserted into another device (such as a MP3 player, cell phone, or the like) to provide the benefits of media player 400 described herein. For example, all the components of the media player 400 except for a wireless transceiver can be available as a separate device that can be connected/inserted into another device that already has a wireless transceiver.

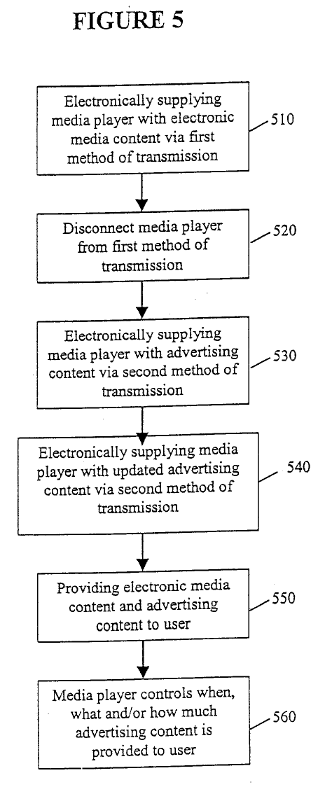

FIG. 5 is a flow chart illustrating an alternative embodiment of the present invention wherein the media player is electronically provided with the electronic media content via the first method of transmission at 510. The media player is disconnected from the first method of transmission at 520. The media player is then electronically provided with advertising content via the second method of transmission at 530, while the media player is disconnected from the first method of transmission. Additionally, while disconnected from the first method of transmission, the media player is electronically provided with updated advertising content via the second method of transmission at 540. The electronic media content and the advertising content is provided to the user at 550, however, prior to the electronic media content being provided to the user, the electronic media content is decrypted, such as described herein. The media player controls when, what or how much of the advertising content is provided to the user at 560.

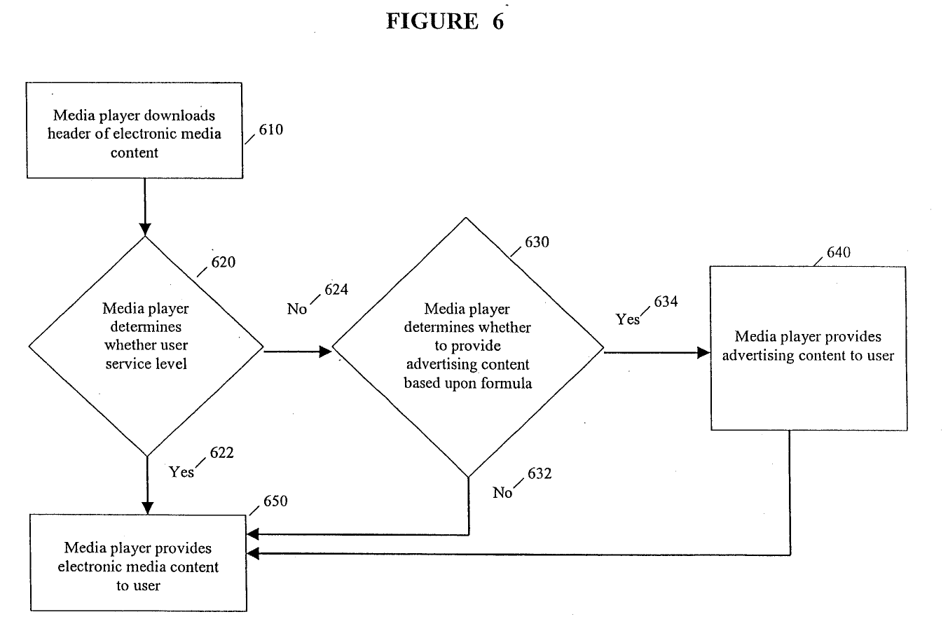

FIG. 6 is a flow chart illustrating another embodiment of the present invention showing how the media player determines whether advertising content is to be played. The media player downloads the header of the electronic media content at 610. The media player determines the service level of the electronic media content. The service levels include, but are not limited to, a premium service level wherein the user has already paid for the electronic media content, a medium service level wherein the user has already paid for part of the electronic media content, and a standard service level wherein the user has not paid for the electronic media content 620.

Depending on the service level, the media player, such as via the advertising control modules, determines whether or not advertising content is to be played. If the media player determines the service level is premium at 622, then the media player provides the electronic media content to the user at 650 without playing advertising content.

If the media player determines the service level is not premium at 624, then advertising content is to be provided to the user and the media player determines whether it is time to provide advertising content to the user (based upon a formula) at 630. The formula includes, but is not limited to, consideration of the number of times electronic media content has been played, the length of time in between advertisements, the volume level during advertisements or the age of the advertisements, and the like, as described above. If advertising content is not to be played at 632, then the media player provides the electronic media content to the user at 650. If advertising content is to be played at 634, then the media player provides the advertising content to the user at 640 and the media player provides the electronic media content to the user at 650.

According to another embodiment, the media player uses a play list from which to play electronic media content. Using the play list, the media player will play electronic media content from the play list, either randomly or as selected by the user from the play list. The play list can be transferred continuously to the media player via the first method of transmission. Alternatively, the play list can be stored on the media player. By using the play list, which is a limited number of different electronic media content, the user could be subjected to fewer advertisements or alternatively no advertisements.

An embodiment of the invention as disclosed herein, provides a means for distributing copyrighted media at little to no cost to the user by using two methods of transmission while providing a means for compensating the owner of electronic media content. With this invention, the use of copyrighted media is paid for at least in part by sponsors who pay to have advertisements mixed into the delivery of the electronic media content to the user. In this manner, copyright holders can receive payment for the use of their electronic media content. In addition, the electronic media content is secured to protect the copyright holders from illegal copying. Moreover, the advertising content is continually updated in order to keep the information current and to retain user interest. Further, advertisers are benefited because the advertising can be targeted to users with particular interests or to users of specific electronic media content which will increase the value and effectiveness of the advertisements.

In addition, according to an embodiment, the distribution of copyrighted media is consistent with the expectation of receiving free electronic media content. Users are familiar with free television and free radio programming because it is supported by advertisement revenues. Such free service is provided in an embodiment of the invention by having customized advertisements pay for the distribution and use of electronic media content.

The methods and apparatus of the present invention, or certain aspects or portions thereof, may take the form of program code (e.g., instructions) embodied in tangible media, such as memory storage devices, wherein, when the program code is loaded into and executed by a machine, such as a computer, the machine becomes an apparatus for practicing the invention. The methods and apparatus of the present invention may also be embodied in the form of program code (such as electronic media content) that is transmitted over some transmission medium, such as over electrical wiring or cabling, through fiber optics, wirelessly, or via any other form of transmission (such as an electronic connection), wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

The steps depicted in flow charts and methods herein may be performed in a different order than as depicted and/or stated. The steps shown herein are merely exemplary of the order these steps may occur. The steps shown herein may occur in any order that is desired, such that the goals of the claimed invention are still achieved. Additionally, steps not desired to be used from the steps shown in the flow charts and methods may be eliminated, such that the goals of the claimed invention are still achieved.

All patents and publications described herein are hereby incorporated by reference to the same extent as if each individual patent or publication was specifically and individually indicated to be incorporated by reference.

One skilled in the art would readily appreciate that the present invention is well adapted to carry out the objects and obtain the ends and technical advantages mentioned, as well as those inherent therein. The specific systems and methods described herein as presently representative of preferred embodiments are exemplary and are not intended as limitations on the scope of the invention. Changes therein and other uses will occur to those skilled in the art which are encompassed within the spirit of the invention are defined by the scope of the claims.

It will be readily apparent to one skilled in the art that modifications may be made to the invention disclosed herein without departing from the scope and spirit of the invention. The invention illustratively described herein suitably may be practiced in the absence of any element or elements, limitation or limitations which is not specifically disclosed herein. The terms and expressions which have been employed are used as terms of description and not of limitation, and there is not intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group. For example, if there are alternatives A, B, and C, all of the following possibilities are included: A separately, B separately, C separately, A and B, A and C, B and C, and A and B and C.

Thus, additional embodiments are within the scope of the invention and within the following claims.

We claim:

1. A method of electronically providing electronic media content and advertising content, said method comprising the steps of:
providing a media player;
providing electronic media content;
providing advertising content;
electronically providing said media player with said electronic media content via a first method of transmission;
electronically providing said media player with said advertising content via a second method of transmission; and
wherein said media player provides said electronic media content to a user and further wherein said media player electronically controls when said advertising content is provided to said user.

2. The method of claim 1, wherein said electronic media content is provided by a electronic media content provider and said advertising content is provided by an advertising content provider.

3. The method of claim 2, wherein said advertising content provider pays a payment to have its advertising content played on said media player and said electronic media content provider is paid at least a portion from said payment.

4. The method of claim 1, wherein said advertising content comprises advertisements and said media player comprises an advertising control module, wherein said advertising control module determines when to play advertisement(s) and which of said advertisement(s) to play.

5. The method of claim 1, wherein said media player comprises a user interface.

6. The method of claim 1, wherein said media player collects and stores user data.

7. The method of claim 6, wherein said user data is electronically provided to a provider of said advertising content.

8. The method of claim 1, wherein said electronic media content is secure and is not capable of being played without use of access data associated with said secured electronic media content.

9. The method of claim 1, wherein said media player determines whether to allow said media player to play electronic media content based upon access rules.

10. The method of claim 1, wherein said second method of transmission is a wireless transmission.

11. The method of claim 10, wherein said first method of transmission is a high bandwidth transmission.

12. The method of claim 10, wherein said first method of transmission is a connection to the Internet.

13. The method of claim 1 further comprising:
providing access data, wherein said electronic media content is encrypted and said access data is related to said encrypted electronic media content;
electronically providing said media player with said access data;
determining whether access rules have been satisfied;
decrypting said encrypted electronic media content using said access data; and
wherein said media player provides said electronic media content to a user after said steps of determining and decrypting.

14. The method of claim 13, wherein said step of electronically providing said media player with said access data comprises electronically providing said media player with said access data via a third method of transmission.

15. The method of claim 14, wherein said access data is delivered from a provider of said electronic media content to a coordination system via a fourth method of transmission.

16. The method of claim 1, wherein said media player reads said electronic media content from a memory storage device.

17. The method of claim 1, wherein said first method of transmission and said second method of transmission are the same type of method of transmission.

18. The method of claim 1, wherein said first method of transmission and said second method of transmission are different types of methods of transmission.

19. The method of claim 1, wherein said media player can receive data but cannot transmit data.

20. The method of claim 1, wherein said advertising content is provided to said user based upon advertising criteria.

21. The method of claim 1, wherein said media player determines whether to play said advertising content based upon a service level.

22. The method of claim 21, wherein said service level is stored in a header of said electronic media content.

23. The method of claim 1, wherein said media player is used with an automobile audio or video device.

24. The method of claim 1, wherein said media player is used with an airplane audio or video device.

25. The method of claim 1, wherein said media player is used with a cellular phone.

26. The method of claim 1, wherein said media player transmits instant text or audio messages.

27. The method of claim 1, wherein a provider of said electronic media content is compensated at least in part, directly or indirectly, by a provider of said advertising content.

28. The method of claim 1, further comprising the steps of:
disconnecting said media player from said first method of transmission wherein said media player ceases to receive electronic media content via said first method of transmission; and
updating said advertising content in said media player via said second method of transmission.

29. A media player that electronically provides electronic media content and advertising content comprising:
an electronic media content storage device, wherein said electronic media content storage device receives and stores electronic media content;
an electronic advertising content storage device, wherein said electronic advertising content storage device receives and stores advertising content;
an output component that outputs said electronic media content and advertising content to a user, wherein said electronic media content that is encrypted is decrypted prior to being output; and
an advertising control module, wherein said advertising control module electronically controls when advertising is provided to said user.

30. The media player of claim 29, wherein said advertising content comprises pre-loaded advertising content that has been pre-loaded onto said media player.

31. The media player of claim 29, wherein said electronic media content storage device and said electronic advertising content storage device are the same device.

32. The media player of claim 29, wherein said media player comprises pre-loaded electronic media content that has been pre-loaded onto said media player.

33. The media player of claim 29, wherein said electronic media content storage and device and said advertising content storage device comprises a SIM.

34. The media player of claim 29, wherein said media player further comprises a decryption module that decrypts electronic media content that has been encrypted.

35. The media player of claim 34, wherein said media player further comprises an access data storage device that receives and stores access data, wherein said decrypting module uses access data to decrypt said electronic media content that has been encrypted.

36. The media player of claim 35, wherein said access data storage device receives said access data via a third method of transmission.

37. The media player of claim 36, wherein said media player receives said encrypted electronic media content via a first method of transmission and said advertising content via a second method of transmission.

38. The media player of claim 29, wherein access rules determine whether said media player can output said electronic media content.

39. The media player of claim 29, wherein said media player can receive data but cannot transmit data.

40. The media player of claim 29, wherein said media player can receive and transmit data.

41. The media player of claim 29, wherein said media player receives said electronic media content and said advertising content via a first method of transmission.

42. The media player of claim 29, wherein a service level is stored in a header of said electronic media content and said media player determines whether to play said advertising content based upon a service level.

43. Computer executable process steps operative to control a computer, stored on a computer readable medium, comprising:
a plurality of steps to receive data required for subsequent calculations; and
a plurality of steps to automatically control when advertising content is provided to a user via a media player based on electronic media content that is provided by said media player to said user.

44. The steps of claim 43, wherein said plurality of steps to automatically control when advertising content is provided comprises consideration of demographics of said user.

45. The steps of claim 43, wherein said plurality of steps to automatically control when advertising content is provided comprises consideration of demographics of said electronic media content.

46. The steps of claim 43, wherein said plurality of steps to automatically control when advertising content is provided comprises consideration of a number of times said electronic media content has been played by said media player without playing said advertising content.

47. The steps of claim 43, wherein said plurality of steps to automatically control when advertising content is provided comprises consideration of demographics of said user, demographics of said electronic media content and a number of times said electronic media content has been played by said media player without playing said advertising content.

48. The steps of claim 43, wherein said electronic media content is encrypted and access data is provided to decrypt said electronic media content.

49. The method of claim 43, wherein said media player can receive data but cannot transmit data.

50. A method for electronically providing electronic media content and advertising content, said method comprising:
providing a media player;
providing electronic media content, wherein said electronic media content is from an electronic media content provider;
electronically providing said media player with said electronic media content via a first method of transmission;
disconnecting said media player from said first method of transmission wherein said media player ceases to receive electronic media content via said first method of transmission; and
after said step of disconnecting, electronically providing said media player with advertising content via a second method of transmission.

51. The method of claim 50, further comprising the step of electronically providing said media player with updated advertising content via said second method of transmission.

52. The method of claim 50, wherein said media player provides electronic media content and advertising content to a user and further wherein said media player controls when advertising is played by said media player.

53. The method of claim 50, wherein said advertising content comprises advertisements and said media player comprises an advertising control module, wherein said advertising control module determines which of said advertisements to play.

54. The method of claim 50, wherein said media player collects and stores user data.

55. The method of claim 54, wherein said user data is electronically provided to a provider of said advertising content.

56. The method of claim 50, wherein said electronic media content is encrypted, said method further comprising decrypting said electronic media content.

57. The method of claim 56, further comprising access data, wherein said access data is used to decrypt said electronic media content and said access data is provided via a third method of transmission.

58. The method of claim 50, wherein said media player determines whether to allow said media player to play electronic media content based upon access rules.

59. The method of claim 50, wherein said second method of transmission is a wireless transmission.

60. The method of claim 50, wherein said advertising content is provided to said user based upon advertising criteria.

61. The method of claim 50, wherein said media player determines whether to play said advertising content based upon a service level.

62. The method of claim 50, wherein said advertising content provider pays a payment to have its advertising content played on said media player and said electronic media content provider is paid at least a portion from said payment.

63. The method of claim 50, wherein said media player can receive data but cannot transmit data.

64. The method of claim 50, wherein said media player can receive and transmit data.

65. A method of electronically providing electronic media content and advertising content, said method comprising the steps of:
providing a media player;
providing electronic media content;
providing advertising content;
providing access data regarding said electronic media content;
electronically providing said media player with said electronic media content via a first method of transmission;
decrypting said electronic media content;
electronically providing said media player with said access data via a third method of transmission, wherein said media player provides said electronic media content to a user after said step of electronically providing said media player with said access data and after said step of decrypting;
disconnecting said media player from said first method of transmission wherein said media player ceases to receive electronic media content via said first method of transmission; and
after said step of disconnecting, electronically providing said media player with advertising content via a second method of transmission.

66. The method of claim 65, wherein said media player electronically controls when said advertising content is provided to said user.
